(19) United States
(12) Patent Application Publication
(10) Pub. No.: US 2011/0090181 A1
(43) Pub. Date: Apr. 21, 2011

(54) SYSTEM WITH A STYLUS FOR OPERATING AN ELECTRONIC DEVICE AND A STORAGE DEVICE AND METHOD FOR ORIENTING A STYLUS

(75) Inventor: Michail Maridakis, Augsburg (DE)

(73) Assignee: Fujitsu Technology Solutions Intellectual Property GmbH, Munich (DE)

(21) Appl. No.: 12/908,905

(22) Filed: Oct. 21, 2010

(30) Foreign Application Priority Data
Oct. 21, 2009 (DE) 10 2009 050 191.6

(51) Int. Cl. G06F 3/033

(52) U.S. Cl. 345/179

(57) ABSTRACT

A system for operating an electronic device includes a storage device, a stylus having a projection, and a structure on an interior side of the storage device on which a projection slides such that when the stylus is inserted into the storage device, the stylus rotates relative to the storage device during insertion and is moved into a predetermined orientation among a group of predetermined orientations.

### RELATED APPLICATIONS

This application claims priority of German Patent Application No. 10 2009 050 191.6, filed Oct. 21, 2009, the subject matter of which is incorporated herein by reference.

### TECHNICAL FIELD

This disclosure relates to a system with a stylus for operating an electronic device and a storage device into which the stylus can be inserted, as well as a method for orienting a stylus in a storage device for the stylus.

### BACKGROUND

Electronic devices that can be operated with a stylus, via a touch screen for example, are being increasingly used. The electronic device can be, for example, a mobile telephone or a notebook, i.e., a portable computer. A tablet computer, i.e., a portable computer operable with a stylus, is also conceivable. The electronic device can be controlled by the stylus and an operating element on the electronic device such as a touch screen. For instance, a graphical symbol represented on the touch screen can be tapped to start a program. The stylus can also be used as an electronic writing device for selecting menu items or for navigating through the programs.

When the stylus is not needed, for example, when the electronic device is not in operation or during transport, the stylus can be positioned in a storage device. The storage device can be mounted on the electronic device, or integrated into it. Such a solution is known from U.S. Pat. No. 7,508,383 B2.

An incorrect alignment or orientation of the stylus when it is being inserted into the storage device can lead to damage of the stylus or the storage device. It could therefore be helpful to prevent such damage. In addition, it could be helpful to provide a corresponding method for positioning the stylus in the storage device.

### SUMMARY

I provide a system for operating an electronic device including a storage device, a stylus having a projection and, a structure on an interior side of the storage device on which a projection slides in such a manner when the stylus is inserted into the storage device, that the stylus rotates relative to the storage device during insertion and is moved into a predetermined orientation among a group of predetermined orientations.

I also provide a system for operating an electronic device including a storage device which has a projection on an inside portion thereof, a stylus which can be inserted into the storage device and a structure provided on an outside portion of the stylus, wherein the projection slides on the structure in such a manner when the stylus is inserted into the storage device that the stylus rotates relative to the storage device during insertion and is moved into a predetermined orientation among a group of predetermined orientations.

### BRIEF DESCRIPTION OF THE DRAWINGS

FIG. 1 shows a stylus.

FIG. 2 shows another stylus.

FIG. 3 shows yet another stylus.

FIG. 4A shows a plan view of a storage device.

FIG. 4B shows a part of a cross-sectional view of the storage device.

FIG. 4C shows a part of a cross-sectional view of an additional storage device.

FIGS. 5-9 show several structures.

FIG. 10 shows a system with a stylus and a storage device.

### LIST OF REFERENCE SYMBOLS

1 Stylus

2 Tip

3 Head

4 Stylus body

5 Projection

6 End area

7 Rocker switch

8 Eraser

9 Eyelet

10 Storage device

11 Outer sleeve

12 Inner sleeve

13 Structure

15 Peak

16 Valley

17, 23 Ramp

18 Ridge

19 Shaft

20 Fixation means

21 Point closest to the tip

22 Point farthest from the tip

### DETAILED DESCRIPTION

It will be appreciated that the following description is intended to refer to specific examples of structure selected for illustration in the drawings and is not intended to define or limit the disclosure, other than in the appended claims.

A system with a stylus for operating an electronic device and a storage device into which the stylus can be inserted is provided. The stylus has a projection and, on the interior side of the storage device, a structure is provided on which the projection slides in such a manner when the stylus is pushed or inserted into the storage device that the stylus rotates relative to the storage device during insertion and is moved into a predetermined orientation among a group of predetermined orientations.

Alternatively, a system is provided in which a structure is provided on the outside of the stylus and the interior side of the storage device has a projection, along which the structure slides in such a manner when the stylus is being inserted into the storage device that the stylus rotates relative to the storage device during insertion and is moved into a predetermined orientation among a group of predetermined orientations.

A method for orienting a stylus, for operating an electronic device, in a storage device provides that the stylus rotates relative to the storage device while being pushed into the storage device and moves into a predetermined orientation from a group of predetermined orientations by virtue of a projection sliding along a structure.

While the stylus is being pushed into the storage device along the longitudinal axis, the stylus is rotated into the predetermined orientation. The system prevents insertion of the stylus with an incorrect orientation which could damage the stylus or the storage device. For a stylus with an area that is not rotationally symmetrical such as buttons, the orientation of the stylus in the storage device prevents damage.

The predetermined orientation is the orientation of the stylus relative to the storage device and means that a reference point on the upper side of the stylus such as the projection or a structured section points in a predetermined direction. The stylus is in the predetermined orientation during insertion if the reference point points in the predetermined direction. The direction is preferably perpendicular or substantially perpendicular to the longitudinal axis of the storage direction. During insertion, the longitudinal axis of the stylus is parallel or substantially parallel to the longitudinal axis of the storage device or coincides with it. It may be noted that the stylus can reach the predetermined orientation during insertion or at the end of insertion, for example, when an end position is reached.

The structures are elevations or projecting areas on the interior side of the storage device, or the exterior side of the stylus so that the projection can rest against the structure at any desired point and can slide from there into the predetermined orientation. It is not necessary to orient the stylus before insertion. Instead, the stylus orients itself during insertion by interaction of the projection and the structure.

The predetermined orientation can be reached in a structure with two ends, for example, when the projection reaches the structure end that is farther from the storage device opening. In a circumferential structure without a beginning and an end, the predetermined orientation and possibly the end position are reached when the projection reaches an extreme point, a local one for example, of the structure curve, for example a curved bottom, that is farther from the opening of the storage device than the adjacent extreme, for example a curve peak.

The stylus can be moved in precisely one predetermined orientation, which makes it possible to adapt the shape of the storage device to the stylus.

The stylus advantageously has a head that is rotatable so that a user can hold or press the head of the stylus during insertion without turning it when the stylus is rotating in its predetermined orientation.

The structure may comprise a first area and a second area, wherein the first area runs from a point in the clockwise direction along the inner side or the outer side and declines in a ramp shape in one direction, and the second area runs counterclockwise from the point and declines in a ramp shape in the same direction. The projection slides along the ramps during insertion of the stylus so that the stylus is rotated into the predetermined orientation. A ramp-like area may decline perpendicularly or nearly perpendicularly.

The structure may comprise a helical section. This section can comprise a fraction of a rotation, one rotation or more than one rotation along the inside of the storage device or the outside of the stylus. The structure and the projection may form a thread which allows the stylus to be screwed into the predetermined orientation.

A notch-like or shaft-like area of the structure may be provided, in which the projection is positioned when the stylus is in the predetermined orientation. When the projection slides into this area, further rotation is prevented.

A fixation means may be provided to hold the stylus in the predetermined orientation, which can be the end position of the stylus. The fixation means can retain the projection with a form fit or a force fit, for example, by friction or locking

Below, my systems will be described in greater detail based on examples, with reference to the figures. Identical reference numbers in the examples indicate identical parts of the arrangement. To avoid repetitions there will not be multiple descriptions of corresponding arrangements.

FIG. 1 shows a stylus 1. The stylus 1 is suitable for operating a touch screen (not shown) of an electronic device (not shown), e.g., for inputting text, creating drawings, selecting menu items, or navigating through programs. This can take place by touching the touch screen or moving the stylus into the vicinity of the touch screen. The electronic device can be, for example, a video game device, a mobile telephone, or a portable computer. For a tablet computer, the inputs with the stylus 1 take place directly on the display screen, and the controlling can be done with tablet keys.

The stylus 1 comprises a stylus body 4 and a head 3. The touch screen is touched by the end, formed as a point 2, of the stylus body 4. In one example, the stylus comprises rotationally symmetrical areas. The head 3 can be rotatably seated with respect to the stylus body 4. The stylus 1 further comprises a projection 5 on the exterior of the stylus 1. The projection 5 can be positioned close to the tip or close to the head or therebetween. The projection 5 can be tab-like, cylindrical, or hill-like in shape. For a stylus 1 with a stylus body 4 having a substantially circular cross section on the line A-A′, the projection 5 is a bulge of the otherwise circular cross section (not shown).

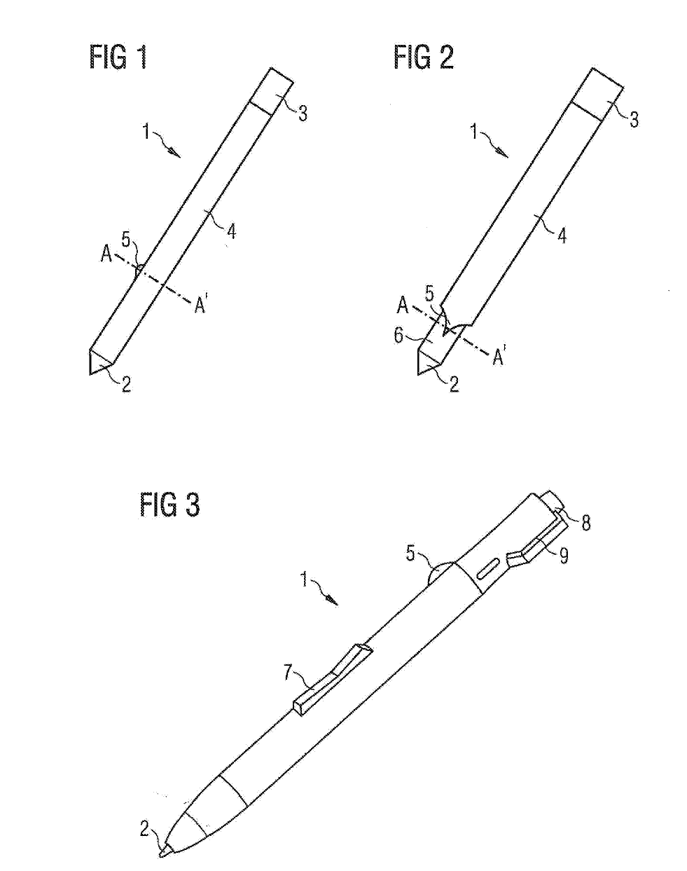

FIG. 2 shows another example of a stylus 1. In this example, the stylus body 4 has a larger radius than an end area 6 of the stylus 1 close to the tip. The projection 5 is an area of the stylus body 4 coming to a sharp point in this example, which extends the farthest in the direction of the tip 2. It may be pointed out that the stylus body 4 that projects radially with respect to the end area 6 forms a structure of which the area closest to the tip constitutes the projection 5. In place of the projection 5, marked by the line A-A′ in FIG. 2, the stylus 1 has a bulge of the circular cross section (not shown).

This stylus 1 can be configured as an electronic stylus, the data of which can be transmitted to the electronic device. FIG. 3 shows an example of an electronic stylus 1 with a rocker switch 7, which can have the function of a left or right mouse button, for example. This stylus 1 further comprises an eraser 8 with which texts or elements on the touch screen can be erased when the head end of the stylus 1 touches the touch screen. In addition, an eyelet 9 is provided for a pen cord (not shown) which is connected to the electronic device (not shown) and prevents the stylus 1 from being lost, for example by falling down.

In addition to selecting menu items or navigating through the programs, such an electronic stylus 1 can serve as a writing instrument for inputting a text by writing with the stylus 1 directly on the touch screen. It can also be used as a drawing device. Due to the eraser function, elements on the touch screen can be erased by moving the eraser 8 over the written or drawn material.

The stylus 1 is generally stored and anchored in a storage device 10, which is constructed, for example, as a stylus shaft. The stylus shaft can be integrated into the electronic device. In one example (not shown), the opening of the stylus shaft is positioned on one side of a notebook, for example, on the side where the connection sockets and/or plug connectors are provided.

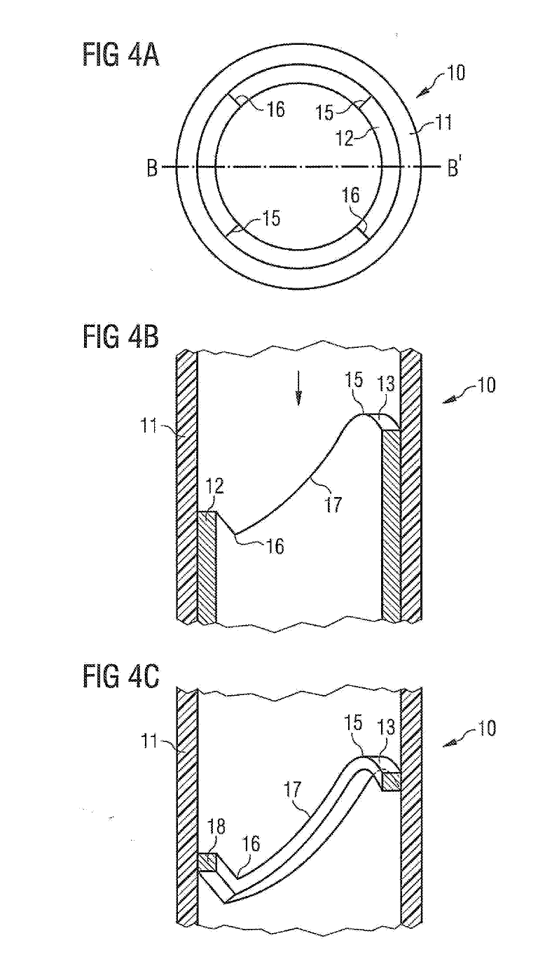

FIG. 4A shows a plan view of an example of a shaft-like storage device 10. FIG. 4B shows a cross section along the line B-B′ through the storage device 10 shown in FIG. 4A.

The storage device 10 is dimensioned with respect to its length in such a manner that the stylus 1 can be inserted at least partially into it. It is advantageously inserted in completely or nearly completely.

The storage device 10 comprises an outer sleeve 11 and an inner sleeve 12 that are connected to one another. The sleeves 11, 12 are elongated hollow bodies with a circular cross section. The upper edge of the outer sleeve 11 is the opening of the storage device 10. In one example, the storage device 10 is constructed in one piece. The storage device 10 is advantageously mounted directly on the electronic device or integrated into it. In one example (not shown), the storage device 10 is a part of the electronic device, for example, part of the housing.

The upper edge of the inner sleeve 12 is a radially inward directed elevation on the inside of the storage device 10 and forms a structure 13 on the inside of the storage device 10.

The structure 11 is formed in a zigzag shape running around the inside of the storage device 10. For example two peaks 15 and two valleys 16 are provided, between which ramp-like sections 17 run. The peaks 15 are rounded off. It is conceivable to round off the valleys 16.

In the insertion of a stylus 1 (not shown in FIGS. 4A, 4B, 4C) into the storage device 10, the stylus 1 is moved with the tip 2 at the front in the longitudinal direction, indicated by the arrow in FIG. 4B, until the projection 5 contacts the structure 13. It may be noted that the stylus 1 is not oriented, so that the projection 5 can contact the structure 13 at any point.

As soon as the projection 5 contacts the structure 13, a rotary motion about a longitudinal axis is forced upon further movement of the stylus 1 in the longitudinal direction, since the projection 5 slides along the structure 13. The movement of the stylus 1 in the longitudinal direction is stopped when the projection 5 reaches the valley 16.

If the projection 5 contacts one of the ramp-like sections 17, it is moved in the direction of the closest valley 16. If the projection 5 contacts the peak 15, it is guided in one direction or another into one of the valleys 16. In case of two valleys 16, the stylus 1 can assume one of two predetermined orientations and end positions. The stylus occupies the end position after insertion.

FIG. 4C shows a sectional area through another example that likewise has the plan view shown in FIG. 4A. It differs from the example shown in FIG. 4B in that the structure 13 is formed by a circumferential ridge 18 on the inside of the storage device 10. The ridge 18 has the same course as the upper edge of the inner sleeve 12 in FIG. 4B. The ridge 18 has a rectangular cross section in this case. Other shapes are conceivable.

In an alternative example (not shown), the structure 13 is not formed circumferentially, but is instead interrupted in an area of the valley 16. The longitudinal movement of the stylus 1 can be stopped by other means, for example, the striking of the stylus tip 2 on the bottom of the storage device 10. In an example of this type as well, the stylus 1 is guided into a predetermined orientation, as soon as the projection reaches the end of the structure at the interruption.

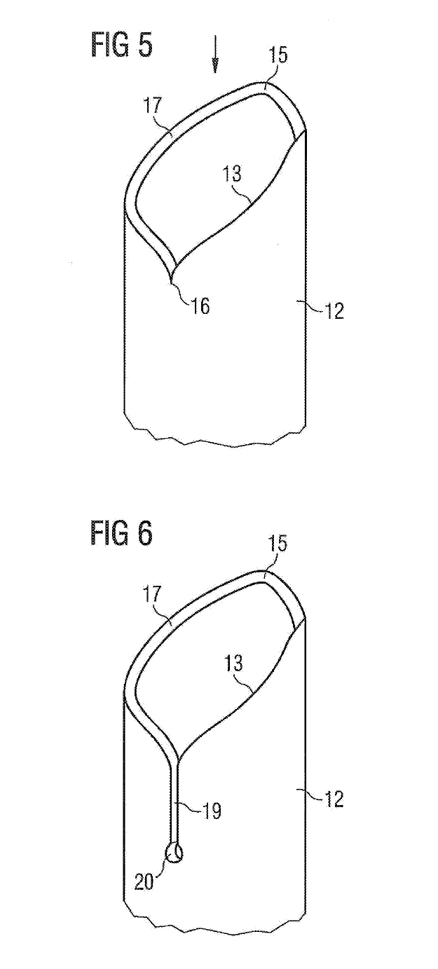

FIG. 5 shows another example of the structure 13. For the sake of clarity, only the inner sleeve 12 of the storage device 10 is shown in this drawing. It may be noted that such a structure 13 can also be formed by a ridge 18. The stylus 1 can be guided in precisely one predetermined direction. The structure 13 has only one peak 15, which is rounded off, and one valley 16, between which ramp-like structure regions 17 run. One runs counterclockwise along the inside of the storage device 10, declining in the direction in which the stylus 1 is inserted. The other runs clockwise along the inside of the storage device 10, declining in the direction in which the stylus 1 is inserted.

In the insertion of the stylus 1 into the storage device 10, the stylus 1 can be moved in the longitudinal direction, which is indicated by the arrow, until the projection 5 contacts the structure 13. As soon as the projection 5 contacts the structure 13, a rotary motion is forced upon further movement of the stylus 1 in the longitudinal direction, since the projection 5 slides along the structure 13. The movement of the stylus 1 in the longitudinal direction is stopped when the projection 5 reaches the valley 16. The valley 16 is formed in a wedge shape, so that a rotational movement of the stylus 1 is avoided as soon as the projection 5, which is advantageously adapted to the shape of the valley 16, reaches the valley 16.

FIG. 6 shows another example of the structure 13. In this case as well, only the inner sleeve 12 is shown for clarity. It may be noted that such a structure 13 can also be formed by a ridge 18. This example differs from the example shown in FIG. 5 in that the valley is shaft-like in shape. In this example, the projection 5 initially runs along the ramp 17 and then along the shaft 19. The stylus 1 reaches the predetermined orientation when the projection 5 is at the beginning of the shaft 19. The orientation is retained when the projection 5 slides down the shaft 19. In addition, a fixation means 20, with which the stylus 1 is fixed in the end position, is provided in this example. In this example, the shaft 19 widens at the lower end, so that the projection 5 tilts and the stylus 1 is protected from accidentally slipping out. Alternatives to the fixation means 20, which fixes the stylus 1 by a force and/or form fit, are conceivable.

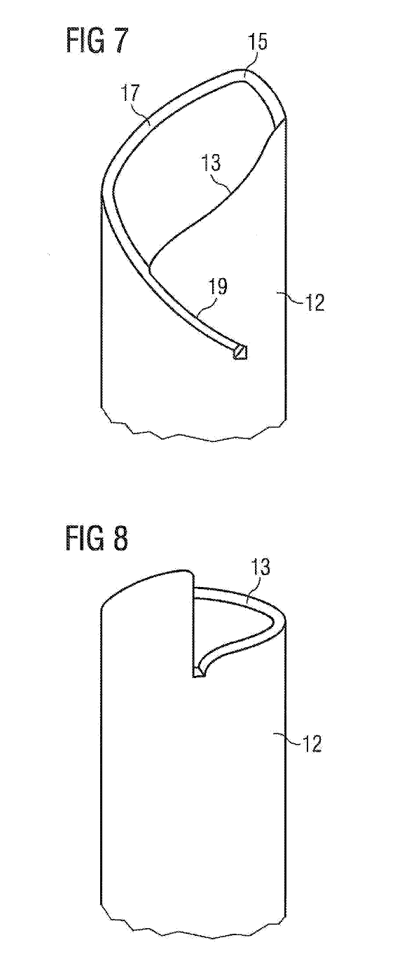

FIG. 7 shows another example of the structure 13. In this case as well, only the inner sleeve 12 is shown. It may be noted that such a structure 13 can also be formed by a ridge 18. This example differs from the previous one in that the shaft 19 does not run vertically, but rather at an incline. This is a helical section, so that when its projection 5 slides along the structure 13, the stylus 1 continues to rotate until it has reached the end of the shaft. In this case, the helical shaft 19 prevents the stylus 1 from falling out, since a rotary motion is necessary for pulling out the stylus 1. When the projection 5 slides along the section 17 running counterclockwise, it is guided to the end of the shaft without changing its direction of motion. When it contacts the other ramp section 17, there is a change in the direction of rotation on the way to the end of the shaft.

FIG. 8 shows another example of the structure 10. In this case as well, only the inner sleeve 12 is shown. It may be noted that such a structure 13 can also be formed by a ridge 18. The structure 13 is formed in a helical shape. It twists along the inside of the storage device 10, declining in the longitudinal direction. The projection 5 slides in the predetermined rotational direction up to the end of the helix. In this example, the helix makes a rotation along the inside of the storage device 10. Shorter helical sections that do not make a full rotation, or longer sections that make more than one rotation, are also possible. In one example (not shown) a vertically falling shaft is provided at the end of the helix.

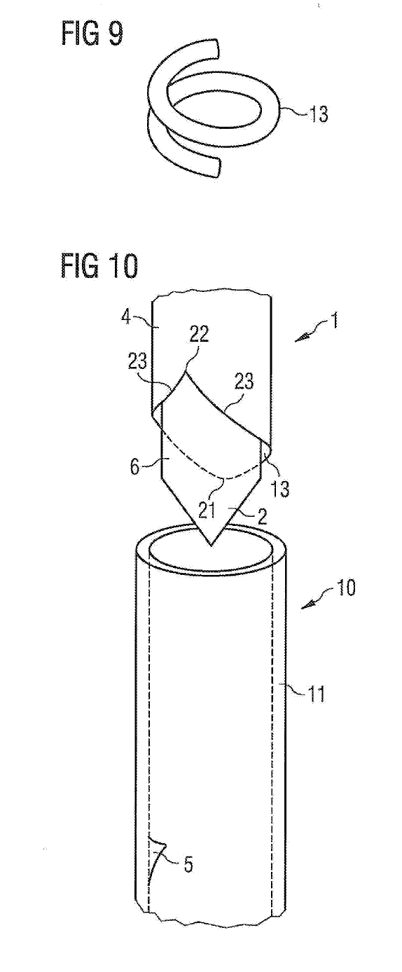

FIG. 9 shows an example of a ridge-like structure 13 that is helical in shape. For the sake of clarity, the representation of the sleeve 12, on whose inside the structure 13 runs, was omitted. This structure runs for 540 degrees along the inside of the storage device 10 and has no stop for the projection 5 at the end of the structure that is farther away from the opening of the storage device. The projection 5 (not shown in FIG. 9) and the structure 13 form a thread. The stylus 1 is rotated in a predetermined orientation. After the passage of the projection 5 through the structure 13, a further longitudinal movement of the oriented stylus 1 is possible. The orientation can be maintained in a further longitudinal motion, for example, by a suitable guide. For example, the stylus shown in FIG. 3 can be oriented after passage of its projection 5 through the structure 13 in such a manner that, if it is pushed in farther, the eyelet 9 slides in recess provided for it (not shown), so that a further rotational movement of the stylus 1 is avoided.

FIG. 10 shows another example of a system with a stylus 1 and a storage device 10. The stylus 1 has a structure 13 that is on the outside of the stylus 1. The structure 13 in this case has a point 21 closest to the tip and a point 22 farthest from the tip, between which ramp-like areas 23 run. The stylus body 4 has a larger radius than the end area 6 of the stylus, wherein the projecting edge of the stylus body 4 forms the structure 13.

The storage device 10 comprises a sleeve 11, on the inside of which a projection 5 is provided. When the stylus 1 is inserted into the storage device 10, the projection 5 contacts the structure 13, and the latter slides along the projection 5 when the stylus 1 is moved farther in the longitudinal direction. Thereby the stylus 1 is set into a rotational motion until the projection 5 has reached the point 22 that is farthest from the tip. Then, the stylus 1 has reached its predetermined orientation and end position. It may be noted that of course the structure that is applied to the stylus 1 can have characteristics or features as represented in FIGS. 4A-9 or mentioned in the description above.

It is conceivable that the projection 5 is the point closest to the opening of a structure (not shown in FIG. 10) running around the inside of the storage device 10, which is formed such that the structure 13 of the stylus 1 and that of the storage device 10 fit into one another when the stylus 1 has reached its predetermined position.

The head 3 of the stylus, as shown in FIG. 2, for example, is advantageously rotatable relative to the stylus body 4. In this case it is possible if the user touches the stylus 1 only at the head 3, for example, by pressing with a finger tip on the head 3 and thus pushing the stylus 1 inward, that as soon as the tip 2 is introduced into the storage device 10, the stylus body 4 rotates into the desired orientation while being pushed in, without the head 3 turning relative to the storage device 10. This facilitates the insertion of the stylus 1.

It may be noted that the characteristics and features represented in the examples can be combined.

Although the apparatus and methods have been described in connection with specific forms thereof, it will be appreciated that a wide variety of equivalents may be substituted for the specified elements described herein without departing from the spirit and scope of this disclosure as described in the appended claims.

What is claimed is:

1. A system for operating an electronic device comprising a storage device, a stylus having a projection and, a structure on an interior side of the storage device on which a projection slides such that when the stylus is inserted into the storage device, the stylus rotates relative to the storage device during insertion and is moved into a predetermined orientation among a group of predetermined orientations.

2. A system for operating an electronic device comprising a storage device which has a projection on an inside portion thereof, a stylus which can be inserted into the storage device and a structure provided on an outside portion of the stylus, wherein the projection slides on the structure such that when the stylus is inserted into the storage device the stylus rotates relative to the storage device during insertion and is moved into a predetermined orientation among a group of predetermined orientations.

3. The system according to claim 1, wherein the stylus can be moved into one predetermined direction.

4. The system according to claim 1, wherein the structure comprises a first area and a second area, and the first area extends from a point in a clockwise direction along an inner side or an outer side and declines in a ramp shape in one direction, and the second area extends counterclockwise from the point and declines in a ramp shape in the same direction.

5. The system according to claim 1, wherein the structure comprises a helical section.

6. The system according to claim 1, further comprising a notch-shaped or shaft-shaped area of the structure in which the projection is positioned when the stylus has a predetermined orientation.

7. The system according to claim 1, further comprising a fixation means that retains the stylus in the predetermined orientation.

8. The system according to claim 1, wherein the stylus has a rotatable head.

9. A method for orienting a stylus in a storage device according to claim 1, comprising inserting the stylus into the storage device such that the stylus rotates relative to the storage device while being inserted into the storage device and moves into a predetermined orientation from a group of predetermined orientations by a projection sliding along a structure.

10. The system according to claim 2, wherein the stylus can be moved into one predetermined direction.

11. The system according to claim 2, wherein the structure comprises a first area and a second area, and the first area extends from a point in a clockwise direction along an inner side or an outer side and declines in a ramp shape in one direction, and the second area extends counterclockwise from the point and declines in a ramp shape in the same direction.

12. The system according to claim 2, wherein the structure comprises a helical section.

13. The system according to claim 2, further comprising a notch-shaped or shaft-shaped area of the structure in which the projection is positioned when the stylus has a predetermined orientation.

14. The system according to claim 2, further comprising a fixation means that retains the stylus in the predetermined orientation.

15. The system according to claim 2, wherein the stylus has a rotatable head.

16. A method for orienting a stylus in a storage device according to claim 2, comprising inserting the stylus into the storage device such that the stylus rotates relative to the storage device while being inserted into the storage device and moves into a predetermined orientation from a group of predetermined orientations by a projection sliding along a structure.
